(19) United States
(12) Patent Application Publication
(10) Pub. No.: US 2009/0230112 A1
(43) Pub. Date: Sep. 17, 2009

(54) Torso Heating Apparatus for Warming Hands and Feet

(76) Inventors: Michel B. Ducharme, Lac Beauport (CA); John Frim, Brampton (CA)

Correspondence Address: GEORGE A. SEABY;SEABY & ASSOCIATES, 250 CITY CENTRE AVNUE, OTTAWA, ON, K1R6K7, CA

(21) Appl. No.: 12/226,767

(22) PCT Filed: May 9, 2007
(86) PCT No.: PCT/CA2007/000806

§ 371 Date: Oct. 28, 2008

(30) Foreign Application Priority Data
May 10, 2006 (US) 60/799022

(51) Int. Cl. H05B 1/00; A41D 1/04

(52) U.S. Cl. 219/211; 2/102

(57) ABSTRACT

A heating vest containing heaters for warming the torso, sensors for detecting skin temperature of the torso, and a feedback device for feeding torso skin temperature to a heater controller. Other sensors detect the skin temperature of the extremities which is also fed to the heater controller. Heating of the torso causes warm blood to flow to the extremities to warm the latter, making it possible to work at relatively cold temperatures without thick coverings on the extremities.

### TECHNICAL FIELD

This invention relates to a body heating apparatus, and in particular to an apparatus for heating a torso for indirect warming of the hands and feet.

### BACKGROUND ART

Cold hand and feet are often the main limitations to work during prolonged exposure to cold. Because blood vessels in the extremities constrict to preserve body heat in the central core, the hands and feet often cool to painfully cold and dangerously low temperatures, even with the insulation provided by mitts and boots. Once the skin temperature of the hands falls below about 15° C. there are significant reductions in comfort, dexterity, tactility, and the performance of tasks requiring fine motor control of the hands and fingers. Thus, there is a problem in keeping the hands and feet warm, particularly on persons who are sedentary or are performing only light work, during which internal body heat production is insufficient to balance heat loss to a cold environment.

At present, the most common solution to the problem of protecting the hands and feet from the cold is the wearing of insulated handwear and footwear. Heated gloves and socks (direct heating) have been developed to assist in maintaining the skin temperature at a comfortable level. This approach relies on external heat instead of internal heat to keep body tissue warm.

However, extra insulation in the form of gloves, mittens, socks, insulated boots, etc., only reduces the rate of cooling, but does not eliminate a drop in skin temperature if the tissues are not perfused with warm blood. The thickness and bulk of such insulation will itself impair dexterity and tactility, and when fine finger dexterity is required, protective insulation is often removed and the work is done with bare hands which could lead to cold injury. The use of direct heating devices in handwear also implies that the handwear must be worn, or removed only briefly, in order to provide protection against the cold. In all cases, dexterity and tactility are compromised. Furthermore, direct heating devices are fragile and prone to breakage because of the constant flex of wires and heating material used in such devices. Heating gloves and socks tend to heat unevenly and to create uncomfortable hot zones.

### DISCLOSURE OF INVENTION

Accordingly, a need exists to provide means for keeping the extremities warm even in the absence of heated handwear or footwear. The object of the present invention is to meet this need by providing a method and an apparatus for controlling the temperature of the torso of a human body which results in indirect heating of the extremities.

In accordance with one aspect, the invention relates to an apparatus for heating a human body comprising a vest; at least one heater in said vest for heating a torso; a controller for controlling operation of said heater; and biofeedback means connected to said controller for detecting skin temperature of the torso and extremities, whereby the controller actuates said heater to heat the torso based on an extremity skin temperature below a threshold value.

In accordance with another aspect, the invention relates to a method of heating a human body comprising the steps of enclosing a torso in a vest; detecting the skin temperature of the torso and extremities of a vest wearer; feeding skin temperature information to a temperature controller in the vest; and heating the torso to a target temperature in response to a reduction of extremity skin temperature below a threshold level.

### BEST MODE FOR CARRYING OUT THE INVENTION

More specifically, the method of the present invention provides for controlled heating of the torso of a human body using a heating vest (indirect heating) to keep the extremities comfortable. The heat delivered to the torso is perceived as excess body heat, and warm blood will flow to the extremities to help dissipate such excess heat. The warm blood raises not only hand and feet temperature, as is done by direct heating, but also warms deeper tissues of the limbs. Heating the muscles and joints of the hands and forearms enhances the dexterity and tactility of the fingers, while heating the muscles and joints of the feet and calves enhances mobility. Because warm blood is sent to the hands during torso heating, no gloves or mitts are required which further improves manual dexterity.

The apparatus of the present invention includes a vest made of a thin flexible heating fabric. In early torso heating experiments, the electrical heaters used in the vest consisted of 10 Kapton™ insulated flexible heaters available from Omega Engineering, Stanford, Conn. including two heaters (each 12×20 cm) on the chest, two heaters (each 8×30 cm) on the abdomen, one heater (8×20 cm) under each armpit, two heaters (each 8×30 cm) over the shoulder area and two heaters (each 15×30 cm) on the back. Thus, the heaters covered a total area of 0.266 m². The flexible heaters can be replaced with resistive heating fabric. The heaters were located in fire resistant pockets made of Nomex™ fabric. In addition, a 1 cm thick layer of Thinsulate™ insulation was placed inside each pocket on the outer surface of the heater. The insulation was covered with a piece of reflective Mylar (trademark) to help reflect radiative heat back to the torso. Once the heaters were placed in the pockets, the pockets were sewn together to form a vest covering an area of 0.366 m². A tight, short sleeve Lycra (trademark) body suit extending to mid-thigh level was worn over the heaters to optimized contact between the skin and the heaters.

Preselected voltages were sent by five current limiting power supplies (two model 6030A, 0-200 V/0-17A, 1000 watt and three model 6034A, 0 -60/V0-19A, 200 watt Hewlett-Packard) to the five pairs of heaters to achieve a skin temperature of 42±0.5° C. under each heater. The power supplies were controlled by a computer.

By the manual adjustment of the power delivered to the heaters, skin temperature under the heaters was kept at 42±0.5° C. to avoid any skin damage by the heat. This skin temperature is considered safe because it has been shown that 45° C. is the critical skin temperature to produce cutaneous burn and to evoke pain. To ensure that the skin temperature under the heaters did not reach 45° C. at any time, the computer turned off the heaters completely if skin temperature reached 44° C.

The temperature of the vest was controlled by biofeedbacks devices, which detect the skin temperature of the fingers and the skin temperature of the torso.

Finger skin temperature (T_{fing}) was measured using a thermistor (YSI 44004 series; Yellow Springs Instruments, Yellow Springs, Ohio) and finger skin blood flow (Q_{fing}) by using a 780-nm laser Doppler flowmeter probe (PF4001 laser Doppler flowmeter, Permed, Stockholdm. Sweden). The probes were placed side by side on the middle fingertips of both hands. The unit of measurement used to represent the skin blood flow is the perfusion unit (PU), a relative unit of blood flow. A calibration standard is used to adjust the laser Doppler flowmeter readings to coincide with the readings obtained with a motility standard. Toe skin temperature (Tₜₒₑ) was measured using a thermistor (YSI 44004 series; Yellow Springs Instruments) placed on the medial side of the big toe of each foot. It is possible to use biofeedback from the upper or lower extremities only. Body thermal comfort (BTC) and mean finger thermal comfort (FTC) were measured every 15 min (starting at time 0) by using the MdGinnis comfort scale. During a control test and a torso heating test rectal temperature (Tᵣₑ) was measured via a thermistor (Pharmaseal 400 series. Baxter, Valencia, Calif.) inserted 15 cm beyond the anal sphincter. Mean body skin temperature Tₛₖ) and mean body heat flow (H_{body}) were measured by using heat flux transducers (HFTs) with embedded thermistors [model HA13-18-10-P(C), Concept Engineering, Old Saybrook, Conn.]. The means body heat flux (in W.^{m-2})for each subject was multiplied by the surface area of the subject (m²) to determine H_{body} (in W). The HFTs were recalibrated, and the values were corrected for the decreased heat flux measurement that occurs because of the thermal resistance of the HFTs (10). The HFTs were placed on the body using a modified version of the HFT sites used by Hardy and DuBois (J. Nutr. 15:461-475, 1938). In this modified version, 10 HFTs were used to represent the heat flux of the heated portion of the body and 10 HFTs were used to represent the unheated regions of the body. The heat flux and skin temperature weighting coefficients for the torso region originally used in the Hardy and DuBois system were modified to represent the heated and unheated areas of the torso. The first biofeedback device provides information to a vest heat microcontroller concerning a need for torso heating based on a threshold finger temperature. The purpose of this first biofeedback device is to maintain optimal finger comfort and dexterity without the intervention of the wearer. The device includes a ring (or rings), which sends thermal information to the vest microcontroller via telemetry. Two rings are used to measure the local temperature on a finger of each hand. Each sensor ring transmits battery voltage for continuous monitoring of a small rechargeable lithium battery incorporated into the ring. Each ring also incorporates a small solar panel for recharging the battery. Exposure to sunlight or an incandescent lamp recharges the battery. The second biofeedback device provides information to the vest heat controller to stop heating when a threshold torso temperature is reached. The purpose of the second biofeedback device is to ensure that the skin temperature of the torso does not reach the burn threshold while staying close to 42° C. to optimize heat delivery to the torso. The second device includes a series of thermal sensors and slave microcontrollers located inside the heating vest close to the skin for sending information to the vest heat controller. The performance of the heating vest depends mainly on three factors: the surface area to be heated, contact with the skin and its insulation from the environment. The vest covers the torso and shoulders to make the surface area to be heated as large as possible. The vest can be inflated to provide a tight fit over the torso by pushing the heating fabric against the skin with a thin layer of air. While inflated, the still air also provides thermal insulation against the environment, optimizing heat transfer to the skin. When not in use, the heating vest can be left deflated to minimize bulkiness.

In summary, radio frequency (RF) transmission modules connected to the torso, finger and toe sensors transmit temperature information to a master microcontroller incorporated in the vest. The master microcontroller integrates the temperature information and transmits signals to slave microcontrollers distributed throughout the vest (one slave microcontroller per heater). The slave microcontrollers use the information to adjust the heating power in their respective regions. The slave microcontrollers return temperature data from their sensors to the master microcontroller. A cut-off circuit in the slave microcontrollers on the upper temperature limit of the vest prevents overheating of the torso.

1. An apparatus for heating a human body comprising a vest; at least one heater in said vest for heating a torso; a controller for controlling operation of said heater; and biofeedback means connected to said controller for detecting skin temperature of the torso and extremities, whereby the controller actuates said heater to heat the torso based on an extremity skin temperature below a threshold value.

2. The apparatus of claim 1 including heaters in the chest, abdomen, armpit, shoulder and back areas of the vest.

3. The apparatus of claim 2, wherein the heaters cover a total area of approximately 0.266 m².

4. The apparatus of claim 2, wherein said biofeedback means includes thermistors for connection to torso, fingers and toes.

5. The apparatus of claim 2, wherein said biofeedback means includes sensors for detecting torso, finger and toe temperatures; and radio frequency transmitters for transmitting temperature information to said controller.

6. The apparatus of claim 5, wherein said controller includes a master microcontroller in said vest for receiving temperature information from said sensors, integrating the temperature information and transmitting signals to slave microcontrollers connected to said heaters.

7. The apparatus of claim 6, wherein said controller includes a slave microcontroller connected to each said heater for adjusting heating in various regions of the vest.

8. The apparatus of claim 7, wherein each said slave microcontroller includes a cut-off circuit on an upper temperature limit for the vest to prevent torso overheating.

9. A method of heating a human body comprising the steps of enclosing a torso in a vest; detecting the skin temperature of the torso and extremities of a vest wearer; feeding skin temperature information to a temperature controller in the vest; and heating the torso to a target temperature in response to a reduction of extremity skin temperature below a threshold level.

10. The method of claim 9, wherein chest, abdomen, armpit, shoulder and back areas of the torso are heated.

11. The method of claim 10, wherein the temperature of the extremities is measured using sensors on at least one of the middle fingertips of the hands and on the medial side of the big toe of each foot.
